(19) United States
(12) Patent Application Publication
(10) Pub. No.: US 2004/0011921 A1
(43) Pub. Date: Jan. 22, 2004

(54) Rotopter hovering and flying by means of circulating wings

(76) Inventor: Vladislav Vasilyevich Gorshkov, Alexandria, VA (US)

Correspondence Address: Vlakislaw Gershkov, 3434A Holly Road, Annandale, VA, 22003, US

(21) Appl. No.: 10/199,069

(22) Filed: Jul. 22, 2002

(51) Int. Cl. B64C 27/22

(52) U.S. Cl. 244/9

(57) ABSTRACT

A helicopter can't moor to a wall or land on slope surface. Maneuvering a helicopter changes angle positions and loses targets. Its screw closes operating space above. Here is given the design of a flying and soaring device (rotopter) free from these problems. It uses side circulating wings whose quasi-horizontal paths of circulation provide necessary thrust for hovering, lifting and flying.

Rotopters can be with one or two thrust delivering plants. The first type rotopter is useful as a personal flying device able also move as a car, a sledge, or a boat propelled by the same thrust plant. The second type rotopter can occupy any angle position. It can tilt, state horizontally or vertically, flying and landing this manner. It can moor to a vertical wall or a cliff providing rescue or assault operations. Automatic redistribution of active power between the thrust plants allows it.

### CROSS-REFERENCE TO RELATED APPLICATIONS

The invention has not analogizes.

### STATEMENT REGARDING FEDERALLY SPONSORED R & D

The author created the invention by himself with own means in duty free time.

### REFERENCE TO A MICROFICHE APPENDIX

Not Applicable.

### BACKGROUND OF THE INVENTION

Definition:

Rotopter—an air flying device winged with horizontally gyrating side circular sets of blades or wings being anytime turned relative its tangent velocity on an attack angle ensuring maximum thrust.

Endeavor:

Creating this invention the author makes an attempt to create a flying apparatus (Rotopter) possessing new useful properties never presented before in artificial flying devices such as a helicopters, airplanes, jet-crafts, etc. These new properties allow the rotopter to accomplish many practical important tasks, which were never done before.

As benefits the rotopter is able to:

hover and moor at vertical walls of buildings, mountains in rescue or assault actions,

land on and take off from hilly surface or water leaving or taking load or personnel,

be on water surface as long as it needs for conducted action before taking off,

hover and hold its frame horizontally, sloppy, or vertically,

fly forward and back, to turn around in a point of hovering,

move upon surface of land or water by using the same thrust plant which lift it up,

go by land, snow, or water and to fly over obstacles temporarily lifting up itself,

sensure operations above its hull.

All of these properties and possibilities open for the rotopter very wide areas of usage. They are in medical and rescue service; police, military, navy, and coastal guard activities; sports; scientific researches; and miscellaneous transportation.

### BRIEF SUMMARY OF INVENTION

The general idea of the claimed invention is an adaptation a flying mechanism of bird flapping wings to conditions of modern engineering having more powerful instruments for mechanization of flying process than the Mother Nature has gave for terrestrial creatures. Instead raising and flap down wings we circulate them around a distancing circulation center. So the wing circular (cylindrical or conical) motion makes wings to participate by turns in two quasi-horizontal flying processes—forward and backward. So a rotopter can hover remaining in the same position as a helicopter does; only its wings accomplish flying process. The wing (blade) conical motion allows reducing active area close fitting to the fuselage.

Here we consider two lifting systems: with flapping rotational blades, with gliding rotational wings or vane arrays. The first system makes blades to revolve only one turn during two whole turns of the star rotor holding these blades on its ends. Symmetrical blades are more effective here than wings because each edge of it becomes in turn leading.

The second system uses gliding wings on ends of the star rotor because these revolve one turn per one turn of the star and so the only one edge of a wing is leading. The system with gliding wings reduces wing resistance not only on ascending circular path and also on descending circular path. Its working paths are the upper and the lower mainly horizontal (quasi-horizontal) paths of the circle.

In both systems there can be used more powerful modern thrust generating devices—vane arrays (polyplane or grid wings) [3]. Special profile of these wings ensures smooth streamlining until attack angles 40-50°, and the thrust (lift force) a few times higher than conventional wings. Its great stiffness is combined with less wing weight and mass.

Notice: we use a term “propellor” to sign herein a universal device that consists of a star rotor with turning blades or wings placed parallel or slightly tilted to rotor axis and used to create thrust by circulating them. It provides such functions as: rotopter lifting, propelling, and maneuverings.

### BRIEF DESCRIPTION OF SEVERAL VIEWS OF DRAWINGS

FIG. 1. General view of a rotopter with the blade star propellor (front view).

FIG. 2. Blade-turning mechanism orienting blades to create thrust (side view).

FIG. 3. General view of blade star with rotating and turning self-carrier blades.

FIG. 4. Theoretical schema of the blade turning eccentric mechanism (for FIG. 5).

FIG. 5. Side view of the blade turning eccentric mechanism (section AA from FIG. 3).

FIG. 6. Controlling of thrust direction by orienting eccentricity to new fixing position.

FIG. 7. Two thrust plant rotopter participating in rescue activities (side view).

FIG. 8. Two thrust plant rotopter participating in rescue activities (above view).

FIG. 9. Picture of rotopter rescue evacuating activities accomplished with shuttle flying.

FIG. 10. A rotopter landing on mountain slope.

FIG. 11. A special carrier rotopter with vertical takings off and landings.

FIG. 12. Rotopter miscellaneous behavior in police or medical activity.

FIG. 13. Splashed-down navigating rotopter propelled by its own propeller.

FIG. 14. Miscellaneous behavior of sledge-rotopter jumping through a frozen river.

FIG. 15. One plant sledge-rotopter additionally rigged by steering propeller (side view).

FIG. 16. One plant sledge-rotopter additionally rigged by steering propeller (front view).

FIG. 17. One plant sledge-rotopter additionally rigged by steering propeller (above view).

FIG. 18. One plant sledge-rotopter (front view) steered with propeller.

FIG. 19. Thrust controlling with lever eccentric mechanism (front view).

FIG. 20. Thrust controlling with lever eccentric mechanism (side view).

FIG. 21. Thrust controlling lever eccentric mechanism (section view).

FIG. 22. Automatic mechanism adapting the wing profile (side section).

FIG. 23. Schema of the wing profile adaptation (O, C—orientation, circulation centers).

FIG. 24. Drawing of the vane array eccentric star propellor (front view).

FIG. 25. Drawing of the vane array eccentric star propellor (side view, section AA, swivel and slip tables are removed).

NUMERIC SYSTEM SIGNING ELEMENTS AND PARTS OF SYSTEMS

| Tens\|___________. | _____________. | ___Units___. | __________. | __________ |
|---|---|---|---|---|
| 0:0 | 1-blade shaft, | 2-bevel gear, | 3-drive shaft, | 4-stiffener, |
| :5-bevel gear, | 6-differential, | 7-hull erection, | 8-cantilever, | 9-blade, |
| 1:0-D-drive, | 1-gear, | 2-turning shaft, | 3-bevel gear, | 4-hollow shaft, |
| :5-bearing, | 6-blade section, | 7-bearing, | 8-drive shaft, | 9-bevel gear, |
| 2:0-air intake, | 1-muff, | 2-control gear, | 3-gear hub, | 4-shaft bulge, |
| :5-blade section, | 6-hub, | 7-spoke, | 8-transmit shaft, | 9-turbine shaft, |
| 3:0-star spoke, | 1-fuselage, | 2-canopy, | 3-key, | 4-bevel gear, |
| 5-fore go blade, | 6-ascend blade, | 7-backing blade, | 8-lowing blade, | 9-bevel gear, |
| 4:0-carrying shaft, | 1-wheel, | 2-trap-door, | 3-jet turbine, | 4-building, |
| :5-slide bush, | 6-satellite, | 7-ductile shaft, | 8-connection, | 9-gear box, |
| 5:0-lead holder, | 1-bearing, | 2-shaft key, | 3-nut, | 4-slide ring, |
| :5-turning axle, | 6-satellite, | 7-still gear, | 8-string, | 9-end bearing, |
| 6:0-steep slope, | 1-disaster room, | 2-refuge room, | 3-spike paw, | 4-load, |
| :5-paw (prop), | 6-ductile shaft, | 7-holder, | 8-turning arm, | 9-propeller, |
| 7:0-skid, | 1-pinion, | 2-worm, | 3-bush part, | 4-roll, |
| :5-bounding cam, | 6-screen, | 7-joystick, | 8-engine, | 9-prop, |
| 8:0-string, | 1-stirrup, | 2-bobbin, | 3-brake, | 4-brake, |
| :5-wing, | 6-bearing, | 7-base armature, | 8-E-drive, | 9-axle-neck, |
| 9:0-worm wheel, | 1-lay shaft, | 2-bevel gear, | 3-bevel gear, | 4-split bearing, |
| :5-bevel gear, | 6-bevel gear, | 7-E-shaft, | 8-bushing, | 9-spoke part, |
| 10:0-spoke part, | 1-joint, | 2-joint, | 3-star boss, | 4-D-shaft, |
| :5-swivel table, | 6-slip table, | 7-rotary disk, | 8-hinge, | 9-key, |
| 11:0-E-pinion, | 1-E-rack, | 2-slit, | 3-axle-screw, | 4-bolt, |
| :5-bush, | 6-hinge, | 7-lever, | 8-edge-axle, | 9-armature, |
| 12:0-trailing edge, | 1-space, | 2-lever, | 3-strip, | 4-aperture, |
| :5-vane array. | | | | |

### DETAILED DESCRIPTION OF INVENTION

1. Propellor Made as a Rotational Star of Flapping Blades.

1.1. Propellor Delivering Thrust for Rotopter (General Description). claim 1.

This rotopter (FIG. 1) consists of: a fuselage 31, a hull erection 7, a transmission, control devices and the blade star propellor kept by the console 8. The transmission passes rotation of (the turbine engine 43 via the shaft 28, engaged bevels 19, 5 the differential 6, drive shafts 3 and 18, muffs 21, carrying 40 and hollow 14 connected shafts) to bosses 23 and 26 of the star propellor. It consists of a four blades (sections 9, 25, 16 connected by a shaft 1), spokes 27 and 30, hubs 23 and 26.

During gyration the blades 35, 36, 37, 38 turn accurate half of what their holding star does. This happens because the geared hub 23 is revolved by shaft 40 via the shaft bulge 24 and hollow shaft 14 holding said hub 23. This compel the gear 11 run round still gear 57 and thus to revolve along with the bevel gear 39, which in turn transmits revolution to the blades via the gear 13, shaft 12, and bevel gear couple 34, 2.

Normally created thrust force directs up vertically becoming totally a lift force. For the rotopter maneuvering the thrust force of each thrust propellor can be reduced or increased, or also, inclined forward or back. Diminishing of produced turbine power can synchronically reduce thrust forces. This compels the rotopter to land whereas the turbine acceleration enforces the rotopter climb up. Applying any of the brakes 83, 84 (FIG. 1) reduces the thrust force of the associated propellor allowing the rotopter to make roll, or bank with combined turn.

The turn is accomplished by opposite thrust inclinations of the propellers. Even thrust inclinations lets the rotopter increase forward or back depending of inclination direction. Described inclining operations are produced by the control drive 10 via the united gears 22 and 57, which need to be turn by said driver to the angle of the same direction and double volume of the desired thrust inclination angle. Then the inclination angle is presented as constant addition to altering blade angle orientations. This is that makes the thrust to be desirable inclined.

1.2. Rough Evaluation for Effectiveness of the Described Flapping Propellor.

The main lift force is the resistance of blade on descending circular path. The blade, flat oriented and possessing velocity V, treats resistance force F determined as follows [1]:

F=C·ρ·A·V\hat{ }2/2, (1)

Where: C—drag coefficient (for our oblong blade [1]:C=1.29),

ρ—air density (=1.23 kg/m\hat{ }3 as given in [1]),

A—maximum projection are of the wing,

V—tangent peripheral velocity.

Hovering rotopter with weight G should develop the lifting force (this is also the resistance force) F=G. So we can find required engine power P=F·V. Substituting G instead F and expressing V from equation (1) we obtain:

P=G·√(2G/(ρCA)). (2)

Taking, for example, G=10 kN (≅1 ton) and A=10 m\hat{ }2, we obtain the required engine power P=476.1 hp.

This example shows little effectiveness of this way creating lift (trust) force as the force resisting to vertical flap down motion of the flat oriented blades. The reason concludes in ignoring the lifting property of a wing that should move perpendicular to the created lifting force. As shown in “Introduction to Fluid Mechanics” [1], the lift force (perpendicular to the wing velocity) succeed the drag force 20-40 times depending of wing profile and attack angle. So taking lift-drag ratio C₁/C_{d}=25 we can expect reducing the required power for the instance engine down to 20 hp. Loses are not considered.

2. Conical Star Propellor Carrying Wings Swinged by Eccentric Gear Mechanism.

2.1. General Notices. claim 2.

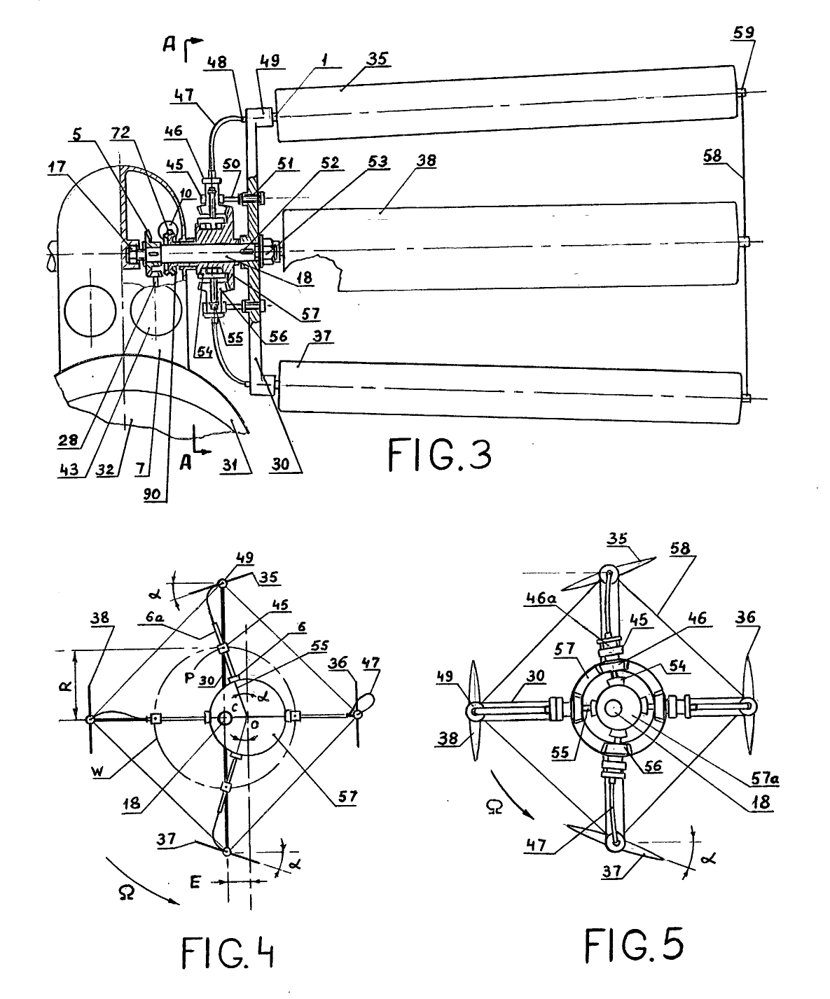

The propellers of this rotopter (FIG. 3) has a star rotor holding the blades 35-38 through spokes 30, gear boxes 49, and shafts 1. The shafts 1 as well as axis of each blade inclined relatively an axis of the drive shaft 18. This makes the thrust propellor conical. Revolving the blades describe conical surface. Remote blade parts draw circles of greater radius allowing reaching greater peripheral velocities. They develop significant centrifugal forces, which are poising each other with strong string or cord 58 connecting them. As stated by [2], “Carbon fiber is many times stronger than steel . . . ” So this material can be used for poising centrifugal forces on the string minimum air resistance and weight. To provide complete poising of the centrifugal forces the strings can be connect the blades or wings stable in few sections.

Conical phantom bodies (described by the conical propellor) can be better allocated upon the rotopter fuselage and adjoining space ensuring required functionality.

As a variant the own turbine engine 43 for each thrust propellor is applied here (FIG. 3) giving opportunity to alter independently lift thrust of any propellor by changing its engine-consumed power. We can also incline the lift thrust direction on desired angle γ by turning the normally still bevel gear 57 on the same angle γ to the same direction. For this action the control system uses the drive 10, the worm 72 and the worm wheel 90 turning said still bevel gear 57. Blade revolution is accomplished by bevel satellites 46, 56 rolling this still bevel gear 57 and transmitting own revolution through ductile shaft 47, connection 48 and geared bearing 49 providing the mean gear ratio 1:1. I.e. one turn of the shaft 18 causes accurate one turn of the blades (35-38) relative the same rotopter system coordinate. It could be useless if the still bevel gear 57 is coaxial with the drive shaft 18. But it is not.

2.2. The Gear Eccentricity Providing Blade Attack Angles Needed for Thrust Forces Rise.

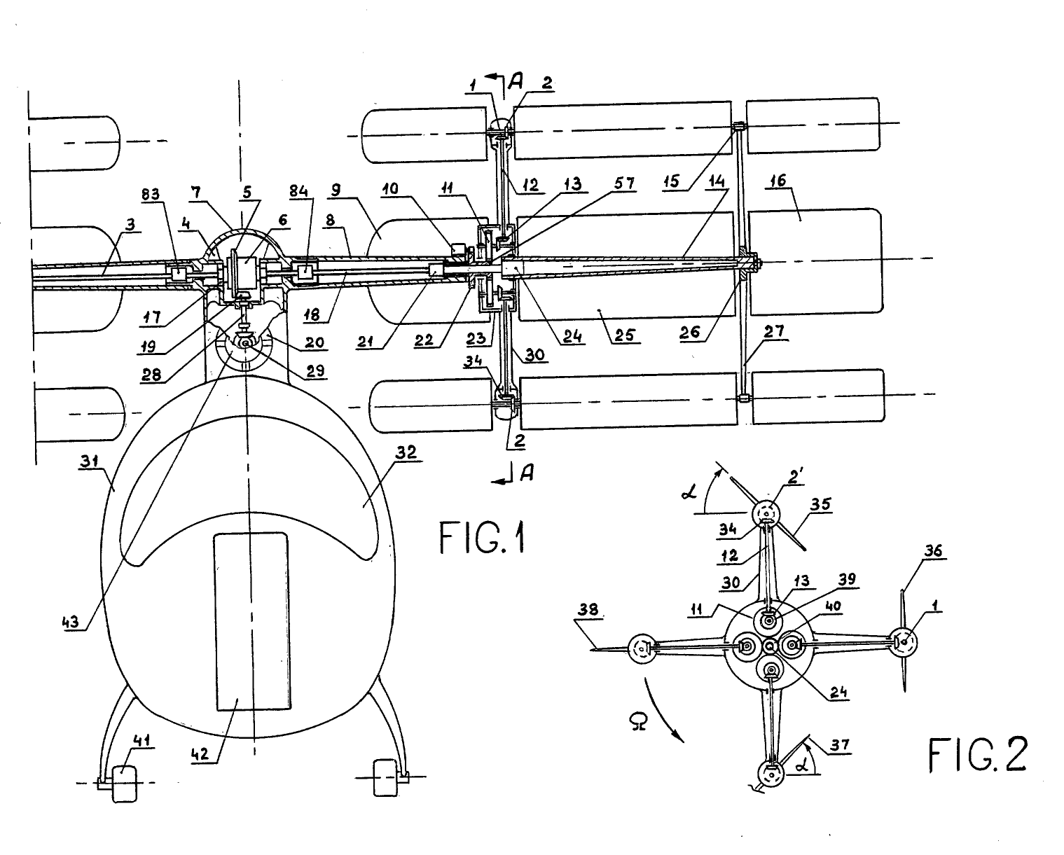

Here we also have new thrust propellor properties. This is variable rate transmission of revolution from drive shaft 18 to blade shaft 1 during the shaft 18 whole turn. So during one turn synchronically with the wing star blades make one swing orienting itself at thrusting attack angles. For that the still gear 57 is not coaxial with the drive shaft 18 as it happens with the united gears 22, 57 (FIGS. 1, 2). Here the still gear 57 is set on the drive shaft 18 eccentrically (FIGS. 3, 5). The center of still gear 57 is the blade or wing orientation center. Distance between the centers of wings orientation and its circulation is the propellor eccentricity.

This gear carries on its neck 57a (FIG. 5) the rings 54 with axles 55 via the sliding bushes 45 holding the bevel satellites 46, 56 (and others) engaged with the still gear 57. When the propellor star is revolved by the drive shaft 18, the star spokes 30 through the leading holders 50 revolve the bevel satellites 46, 56 (and others) round the still gear 57 (FIGS. 3, 5).

As a result the satellites get and transmit their revolution to the blades 35-38 through the ductile shafts 47, connections 48 and geared bearings 49. The last ones ensure total transmitting rate between the still gear 57 and the shafts 1 as great as 1:1 in conditions of rounding this gear by the satellites 46, 56 (and others).

The spokes 30 (FIG. 4) round the center C (the drive shaft 18) whereas the bevel satellites 46, 56 (and others), set on the neck 57a of the still gear 57 (FIG. 5), round the center O remote from the center C as far as E (eccentricity). The holders 50 via its bushes 45 being located on the spokes 30 accomplish this revolving. As we see in FIG. 4, the angle paths passed by the satellites between the 35 and 36 positions and between 36 and 37 positions are greater than π/2 on the angle α=arcsine (E/R). The angle difference between orientations of spokes 30 and bevel gears 46, 56 (and others) axles', connected by holders 50, orient blades to the needed attack angles.

3. Star Propellor Orienting Wings by Lever Eccentric Mechanism.

3.1. Thrust Creation. claim 3.

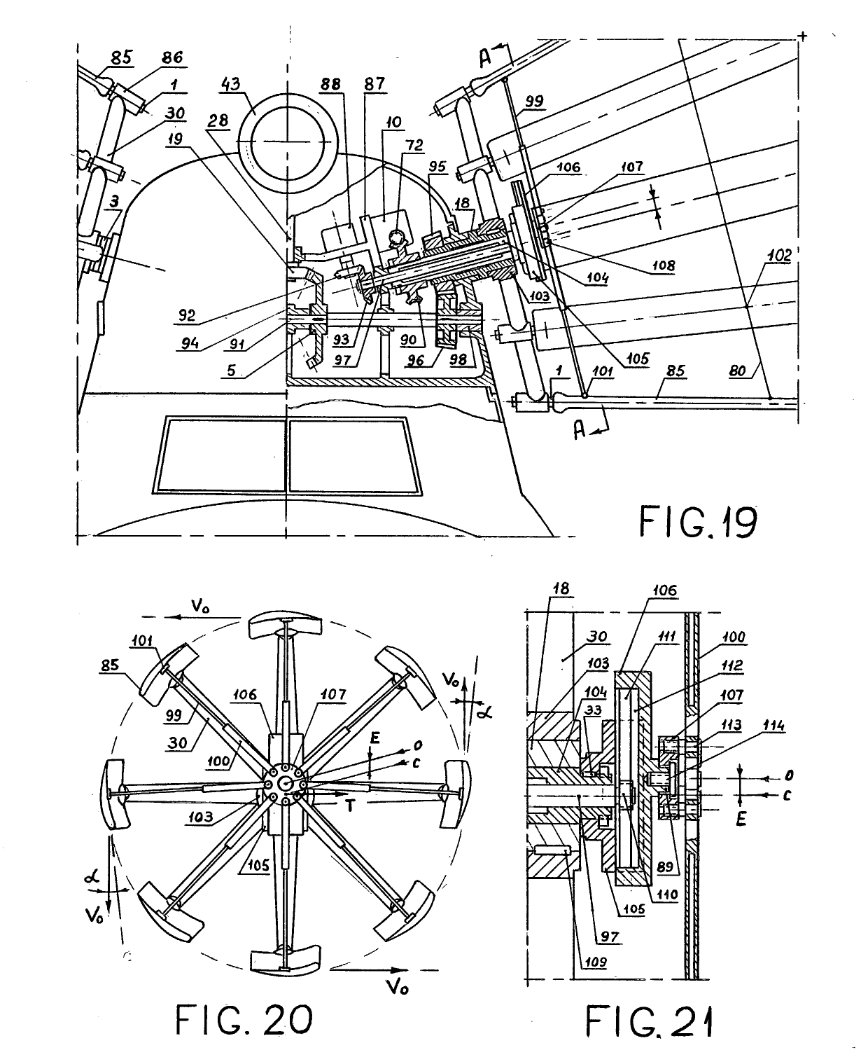

The turbine-engine 43 (FIG. 19), allocated above of the thrust producing plant, transmits its power to the propellor through the shaft 28, bevel gears 19, 5, shaft 91 (splitting power to both propellors), bevel gears 96, 95, the drive shaft 18 and the boss 103 with key 109 (FIG. 21). The disk 107 along with orienting levers 100 rotates on the still eccentric axle-neck 89 where it is fixed with the bolt 114. The disk 107 and wings 85 (FIGS. 19, 20) are connected with telescopic levers consisting each of levers 99, 100 compensating changes of the distance between wing and the disk 107.

When the star propellor revolves around the main axis, i.e. the drive shaft 18 axis (circulation center C), the telescopic levers orient the wings relatively the eccentric axis of the axle-neck 89 (orientation center O) turning or swinging them so as they are always oriented to the orientation center) and have attack angles as shown (FIG. 20). The shown here eccentricity direction makes the left wings to tilt left and the right wings to tilt right. So all left and right wings produced the thrusts (at list its horizontal projections) of the same direction from left to right. All vertical projections are mutually annihilated.

3.2. Thrust Volume and Direction Controlling. claims 4, 5.

This is obviously, if we increase (in proper boundary) the eccentricity E then along with attack angle we increase also the wing thrust. We can get zero-thrust if E=0 (FIGS. 20, 21). The eccentricity E (and so thrust volume) is altered (FIG. 19) by shifting the slip table 106 with E-drive 88 through the bevel gears 92, 93, E-shaft 97, the pinion 110 (FIG. 21) and the rack 111, fixed into longitudinal slit 112 of said slip table 106. The drive 88 can change the propellor eccentricity from some volume E to the negative volume of it—E thus changing the thrust direction to the opposite. It means we have the best method for control the thrust volume without special engine power correction.

To change the thrust direction on some angle γ is enough to turn the propellor eccentricity to the same angle γ. For that (FIG. 19) we need to turn the swivel table 105 at this angle with the D-drive 10 via the worm 72, worm wheel 90, D-shaft 104 carrying and revolving said swivel table 105 with the key 33 (FIG. 21).

Notice: all shafts (D-shaft 97, E-shaft 104 and the drive shaft 18) are inserted coaxial each in other and in the bearings of the base armature 87. They form the mechanical assemble driving and flexible controlling the rotational wing propellor. This propellor is protected against centrifugal forces by strings 80 via connections 102.

3.3. The Propellor Enhancing by the Adapting Profile of the Wings. claim 6.

The attack angle α is an angle rising between the wing chord and the peripheral velocity vector V. As we see in FIG. 20, all wings has identical profile irrespective of their positions. For example, the very right wing, moving up and creating thrust has good conditions for that because its attack angle α associated with this profile the best way. On the other hand the very left wing has negative attack angle α which is not associated with the wing profile proper way. The wing creates the thrust much lesser than the right wing. We are trying here to give the best thrust creating conditions for each wing of the wing star propellor.

Let's do it by, first, making wing basic profile symmetrical, second, making this profile adaptable to positions the wings take. The first action is clear, the second action is the equipping symmetrical wings 85 with trailing edges 120 (FIG. 23), each of which should automatically be turn to the same direction as the chord. As we see, this action adapts the wing profile to the thrust direction. The total propellor thrust is sum of the vertical components of the thrusts of all wings.

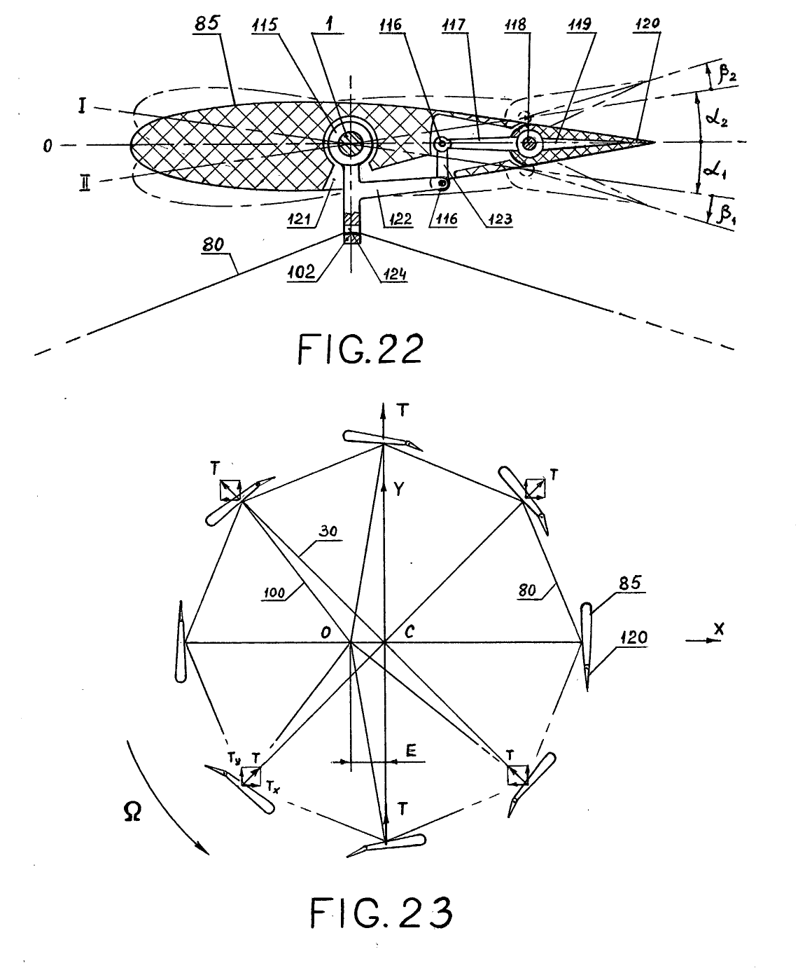

Technically the device, adapting wing profile to the wing position, is based on the join of the wing shaft 1 and the anti centrifugal string 80 which pulls the shaft 1 through the joint 102 with the bush 115 when the wing is bent by the centrifugal force. So the joint 102 is oriented stable to the propellor star center O. We use this join property by adding the lever 122 to it (FIG. 22). Also we add the lever 117 to the armature 119 of the trailing edge 120 and connect both levers 117 and 122 by the strip 123 via hinges 116.

Now when some wing is turned by any method, as it is described before, the lever 122, continuing stay stable pushes or pulls the lever 117. So the trailing edge turns additionally to the same direction as the wing does. This mechanism changes the wing profile as we have wished.

3.4. The Propellor Enhancing by Using the Grid Wings. claim 7.

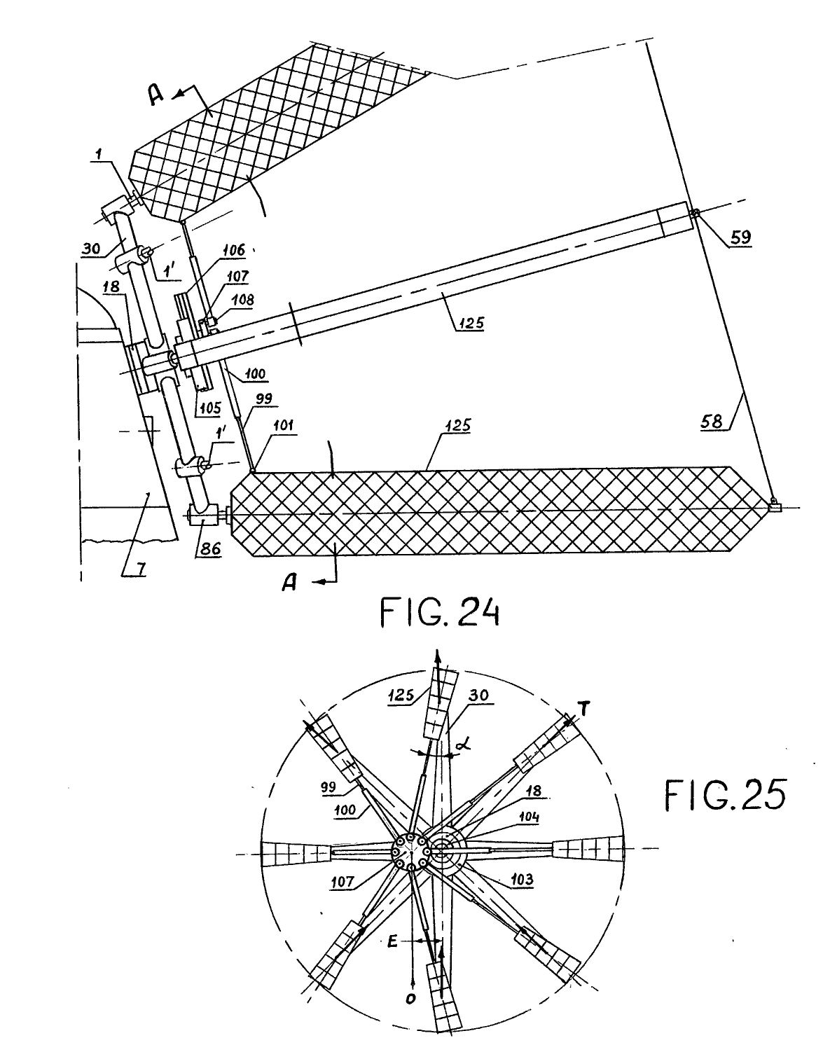

We do it by taking the propellor of the previous paragraphs and substituting wings by the grid wings or vane arrays (FIGS. 24, 25). So the propellor has the same working procedure as described in the p. 3.1. As we see this type of the wing possesses great stiffness. So the only end string 58 is needed here to neutralize the centrifugal forces. When the propellor rotates the tilted (because of the eccentric mechanism) upper arrays push air to the center while the lower arrays push it further out of the center. Each of these arrays creates the own thrust directed opposite to compelled air motion. The vector sum of these thrust is the propellor thrust.

The more propellor eccentricity E the more power is needed to rotate the propellor because the attack angle is increased. However the more total thrust is created. The grid wings allows to be turned up to 40-50 degrees providing smooth streamlining and the thrust a few times greater. This is why the eccentric star propellor is the most convenient application for these kind wings.

All propellers considered here can be enhanced by substituting blades and wings with the vane arrays.

4. Rotopter Maneuvering Methods. claim 9.

4.1. Redistributing Force Moments for Holding a Given Working Position.

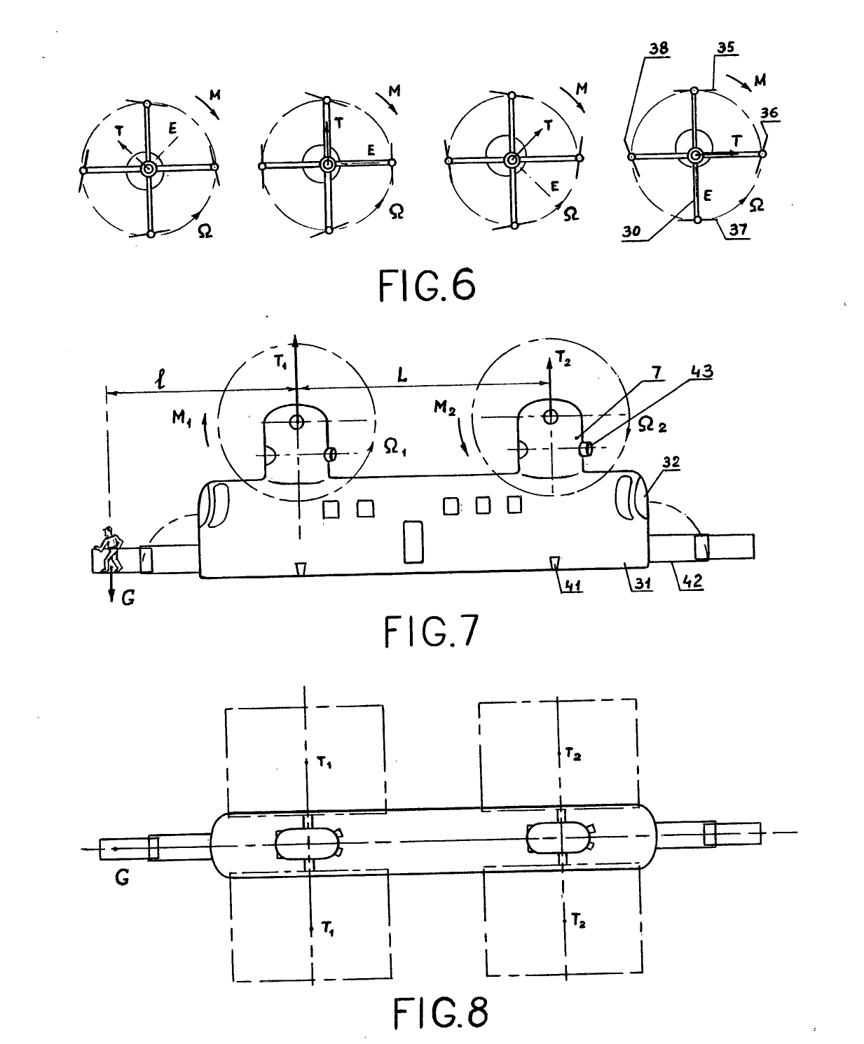

As mentioned before (p.2.1 and p.3.2), a rotopter pilot is able to turn a lift thrust of any propellor to any angle γ forward or back around its drive shaft axis (FIG. 6) with the control drives 10 (FIGS. 1, 3). For that it turns the normally still gear 57 to the angle 2γ (for the flapping blade propellor) and to the same angle γ (for the gliding propellors of the wing or vane array type). As we see (FIG. 6), when a propellor revolves with the velocity Ω (for instance, anti clockwise) the thrust can be turned to any direction including forward, upward, even though downward (we hope an automated control system shall not allow this deadly maneuver). The same maneuvering freedom we have when the propellor revolves clockwise direction.

Based on this we can scrutinize a rotopter with four thrust propellors (FIGS. 7, 8). Fore couple of propellors revolve anti clockwise direction while the aft couple of propellers revolve clockwise. If the rotopter is symmetrical then attributes “fore” and “aft” are conditional. This way of the propellors gyrating ensures higher stability of their interaction because the propellors turquoises M equilibrate each other. To keep stability the automatic control system should accelerate the propellor, near which the load G appears (FIG. 7), and decelerates the remote propellor observing rules:

T₁+T₂=G+R, (3)

(T₁−R/2)·L=G·(L+1), (4)

where: R rotopter weight applied in the middle.

This way equalizes acting force moments and keeps the rotopter in a given working position.

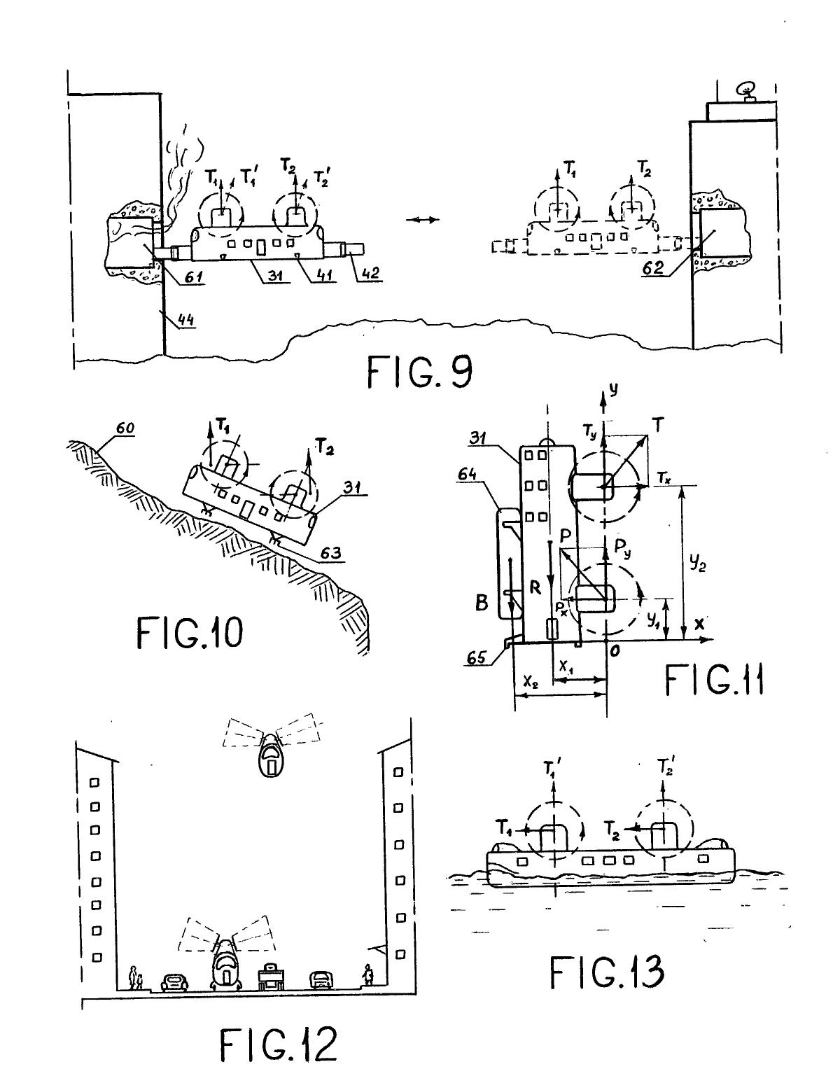

The FIG. 9 illustrates rescue operations providing by a rotopter on a high-altitude building conflagration. Conventional means are helpless here. No one helicopter can take people from firing premises and no one fire ladder can reach them. Our rotopter makes it easy. This is why it can evacuate people many times in the nearest building on opposite side saving their lives. The same method can be realized with this type rotopter in storm operations by any armed forces.

Besides it can provide rescue and other type operations in mountains. Even it can approach close by a sheer rock and take mountaineers on board or land them on small spot. Various mounting and repairing acting can be done with this rotopter.

4.2. Rotopter Body Inclinations for Adapting to Any Landscape or Load.

If lift thrust of each propellor is simultaneously changed on the same angle (FIG. 10) γ then the rotopter inclines its position on the same but opposite angle −γ giving itself opportunity to land on a sloping surface. For that the spike paws 63 rig the rotopter instead wheels or skids. The other exotic example is a special rotopter keeping it flying vertically to orient the same a pipe or a vessel (FIG. 11) which supposedly it will maintain after reaching a required position. A rotopter can take some object from horizontal position, fly up and land this object vertically or other way around. Even cranes can not do these acts.

To keep an object vertically the rotopter pilot should change directions of the propellor thrusts T and P as shown in FIG. 11. If B and R are gravity forces of the object and the rotopter then sum of vertical thrust components T_{y}+P_{y} should be no less than the sum B+R. Also there must be observed the equation Tₓ=Pₓ and the moment equation:

B·X₂+R·X₁=Tₓ·Y₂−Pₓ·Y₁. (5)

It is satisfied by selecting or calculating the appropriate T and P values and also their inclinations γₜ, γₚ.

4.3. Rotopter Acting in Street Emergency.

Because a rotopter keeps its propellors high enough and it can drive itself along a road, reducing and tilting its thrust, it can act in street emergency through landing, driving to emergency place taking people on board and evacuating them by fly up. Special rigged rotopter can even evacuate whole accidental car in order to operate it in appropriate conditions.

4.4. Amphibious Rotopter.

The thrust turning ability allows a rotopter to be amphibious. It can splashdown and navigate as a boat propelling itself with the same thrust propellors (FIG. 13). The great advantage of the rotopter-amphibious concludes in ability to float as long as it needs for an operation. A helicopter can not splash down. To hover it needs to consume fuel constantly. This is why its hovering time is limited. Unlike of it the rotopter-amphibious does not consume fuel to support itself after splashdown.

5. One-Plant Rotopters. claim 8.

5.1. A Rotopter of One Thrust Plant (Design, Applications and Maneuvering).

There can be made and used a rotopter rigged with a single thrust plant consisting of two side propellors as shown for a sleigh-rotopter (FIG. 14). It should have a reliable stable engine and propellors control system guaranteeing constancy of a thrust right value and direction. In this example the rotopter normally uses skids and its propellers to slide above snow as an air-sleigh. However, instead to skirt obstacles it flies (jumps) over it and then continues normal slip run. As we see, the total thrust is turned forward to get horizontal force component F overcoming the air resistance H and it is also increased to get the thrust vertical component U=G.

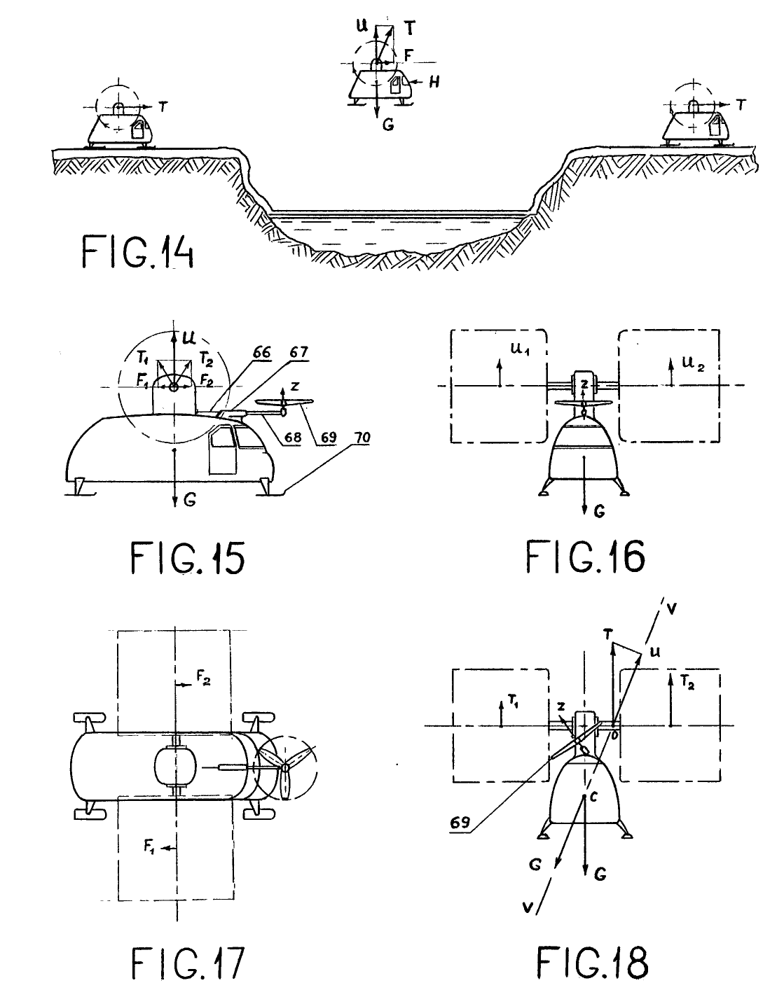

Rigging this type of the rotopter with a small service propeller 69 (FIGS. 15-18) can markedly increase reliability and stability of the rotopter with a single couple of the propellors. The service propeller creates a small thrust force Z that balances disrupting force moments and so keeps the rotopter in required state.

We see in side, front and above rotopter views (FIGS. 15, 16, 17) technique for right turning. The right propellor thrust T1 is turned anti clockwise with angle γ₁ giving the back horizontal force component F₁ whereas the left propeller thrust T₂ is turned clockwise with angle γ₂ giving the forwarded force component F₂. Opposite directed forces F₁ and F₂ and distanced with shoulder S form force moment turning the rotopter right. During rotopter turning the engine should be accelerated to get sum of the thrust vertical component's U₁+U₂=G.

The service propeller 69 (FIG. 18) allows also using the other turning technique which concludes in the propeller tilting to the turning side. So the rotopter can accomplish the same right turn by tilting the service propeller to right side. Simultaneously the rotopter rolls (banks) right with increasing the left thrust T₂ so as the vertical line VV passes the gravity center C and the new total thrust center O.

Technical Literatures:

[1] Y. Nakayama. Introduction to Fluid Mechanics. Published by Arnold. London, 1999.

[2] Secrets of the Universe. Category %. Card 35: Nanotech. International Masters Publishers. 444 Liberty Avenue, Pittsburgh, Pa., 15222-1207.

[3] Structure and design of flying devices. Textbook for aircraft colleges. I. S. Golubev, A. V. Samarin, V. I. Novoseltsev. Moscow, Public house “Mashinostroenie”, 1995.

1. Thrusting device (propellor) that holds its blades parallel or slightly tilted to the rotor axis, spins them evenly turning around their axis' with the gear ratio 1:2 that procures the thrust;
this propellor changes lead edge of each blade for one circulation.

2. The propellor (by claim 1) that spins wings instead blades turning them around their axis' with the average gear ratio 1:1; so to develop thrust the propellor turns the wings unevenly during one circulation orienting them with eccentric gearing to required attack angles.

3. The propellor (by claim 2) using eccentric lever transmission instead the eccentric gearing in order to turn wings unevenly during each circulation to orient them to required attack angles.

4. Method controlling the thrust direction based on turning the center of wings' orientation around the center of their circulation for the angle equal to the desired angle of the thrust direction change.

5. Method controlling the thrust value based on shifting the center of wings' orientation relatively the center of their circulation to distance (eccentricity) ensuring the corresponding change of attack angles' range.

6. Method increasing the propellor wings effectiveness by adapting automatically each wing profile to the new position and orientation on its circulation path.

7. Method increasing the propellor wings or blades effectiveness by substituting them with vane arrays.

8. Flying device (rotopter) with a single thrust plant using on sides couple of any similar propellors driven by an engine; said rotopter is steered by combining changes of thrust directions and values of both propellors; the rotopter steerage and stability can be increased with adding a vertically acting service propellor.

9. Rotopter of two thrust plants using each on sides couple of any similar propellors driven by an engine; said rotopter is steered by combining changes of thrust directions and values of four propellors that enable the rotopter to hover and fly orienting its hull horizontally, sloppily, or vertically, also, to moor to walls, and to land on slopes besides conventional maneuvering.
